(19) United States
(12) Patent Application Publication
(10) Pub. No.: US 2024/0248287 A1
(43) Pub. Date: Jul. 25, 2024

(54) ZOOM LENS AND IMAGING APPARATUS INCLUDING THE SAME

(71) Applicant: CANON KABUSHIKI KAISHA, Tokyo (JP)

(72) Inventor: YASUAKI HAGIWARA, Tochigi (JP)

(21) Appl. No.: 18/419,207

(22) Filed: Jan. 22, 2024

(30) Foreign Application Priority Data
Jan. 25, 2023 (JP) 2023-009357

(51) Int. Cl. G02B 15/14; G02B 15/16

(52) U.S. Cl. CPC G02B 15/1441; G02B 15/16

(57) ABSTRACT

A zoom lens comprises a first lens unit having a positive refractive power, a second lens unit having a negative refractive power, a third lens unit having a positive refractive power, and a subsequent group including three or more lens units, arranged in this order from an object side toward an image side, wherein in zooming from a wide angle end toward a telephoto end, the first lens unit, the third lens unit and all the lens units of the subsequent group move toward the object side, and the second lens unit moves in a trajectory that is convex toward the image side, and wherein predetermined inequalities are satisfied.

### BACKGROUND

### Field of the Disclosure

The present disclosure relates to a zoom lens suitable for use in imaging apparatuses, such as digital video cameras, digital still cameras, broadcasting cameras, and silver-halide film cameras.

### Description of the Related Art

In recent years, imaging optical systems for use in imaging apparatuses are required to have high optical performance, a high zoom ratio, and a small zoom lens.

To obtain an imaging optical system with a high zoom ratio and a small size, Japanese Patent Application Laid-Open No. 2009-86537 discusses an optical system including six lens units.

A zoom lens discussed in Japanese Patent Application Laid-Open No. 2009-86537 includes positive, negative, positive, positive, negative, and positive lens units arranged in this order from an object side toward an image side. Because the second lens unit has a high refractive power, magnification chromatic aberrations often increase at a wide angle end, and changes in field curvature that occur in zooming often become significant.

### SUMMARY

According to an aspect of the present disclosure, a zoom lens comprises a first lens unit having a positive refractive power, a second lens unit having a negative refractive power, a third lens unit having a positive refractive power, and a subsequent group including three or more lens units, arranged in this order from an object side toward an image side, with an interval between adjacent lens units that changes in zooming, wherein in zooming from a wide angle end toward a telephoto end, the first lens unit, the third lens unit, and all the lens units of the subsequent group move toward the object side, and the second lens unit moves in a trajectory that is convex toward the image side, and wherein the following inequalities are satisfied: 3.50<f1/|f2|<5.33, and 0.30<fr/|f2|<2.30, where f1 is a focal length of the first lens unit, f2 is a focal length of the second lens unit, and fr is a combined focal length of the subsequent group at the wide angle end.

Further features of various embodiments of the present disclosure will become apparent from the following description of exemplary embodiments with reference to the attached drawings.

### BRIEF DESCRIPTION OF THE DRAWINGS

FIG. 1 is a cross-sectional view illustrating lenses of a zoom lens according to a first exemplary embodiment at a wide angle end.

FIG. 2A is an aberration diagram illustrating the zoom lens according to the first exemplary embodiment at the wide angle end, FIG. 2B is an aberration diagram illustrating the zoom lens according to the first exemplary embodiment at a zoom intermediate position, and FIG. 2C is an aberration diagram illustrating the zoom lens according to the first exemplary embodiment at a telephoto end.

FIG. 3 is a cross-sectional view illustrating lenses of a zoom lens according to a second exemplary embodiment at a wide angle end.

FIG. 4A is an aberration diagram illustrating the zoom lens according to the second exemplary embodiment at the wide angle end, FIG. 4B is an aberration diagram illustrating the zoom lens according to the second exemplary embodiment at a zoom intermediate position, and FIG. 4C is an aberration diagram illustrating the zoom lens according to the second exemplary embodiment at a telephoto end.

FIG. 5 is a cross-sectional view illustrating lenses of a zoom lens according to a third exemplary embodiment at a wide angle end.

FIG. 6A is an aberration diagram illustrating the zoom lens according to the third exemplary embodiment at the wide angle end, FIG. 6B is an aberration diagram illustrating the zoom lens according to the third exemplary embodiment at a zoom intermediate position, and FIG. 6C is an aberration diagram illustrating the zoom lens according to the third exemplary embodiment at a telephoto end.

FIG. 7 is a cross-sectional view illustrating lenses of a zoom lens according to a fourth exemplary embodiment at a wide angle end.

FIG. 8A is an aberration diagram illustrating the zoom lens according to the fourth exemplary embodiment at the wide angle end, FIG. 8B is an aberration diagram illustrating the zoom lens according to the fourth exemplary embodiment at a zoom intermediate position, and FIG. 8C is an aberration diagram illustrating the zoom lens according to the fourth exemplary embodiment at a telephoto end.

FIG. 9 is a schematic diagram illustrating an imaging apparatus.

### DESCRIPTION OF THE EMBODIMENTS

Optical systems and imaging apparatuses including the same according to exemplary embodiments of the present disclosure will be described below with reference to the attached drawings.

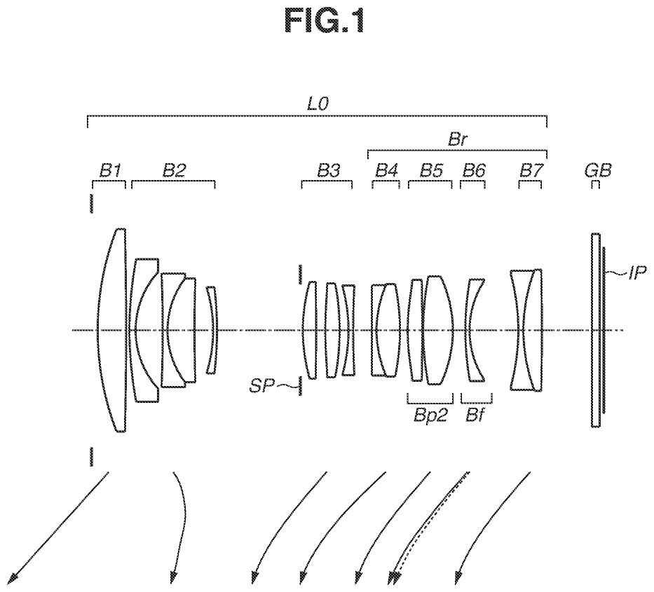

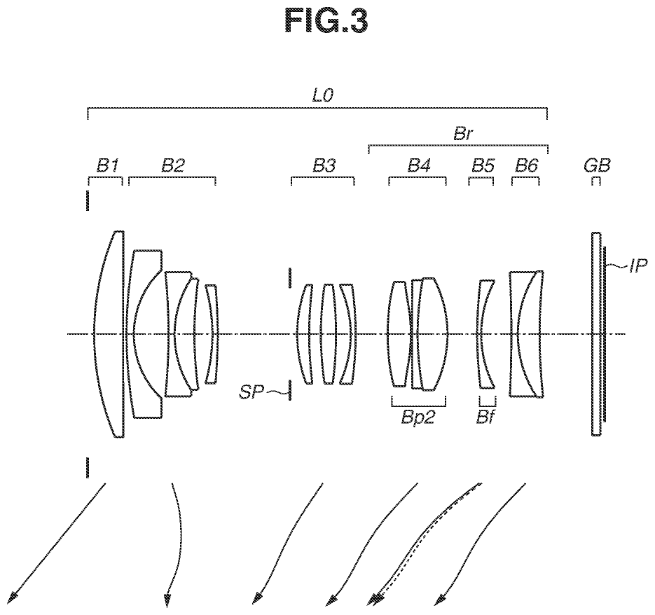

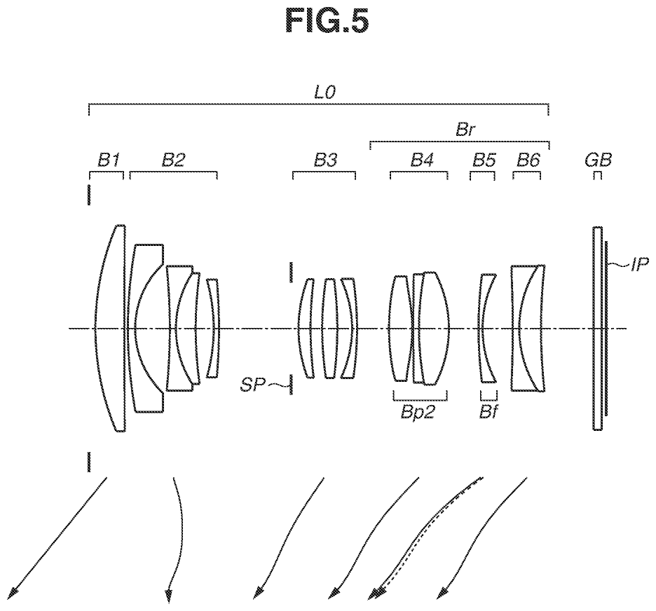

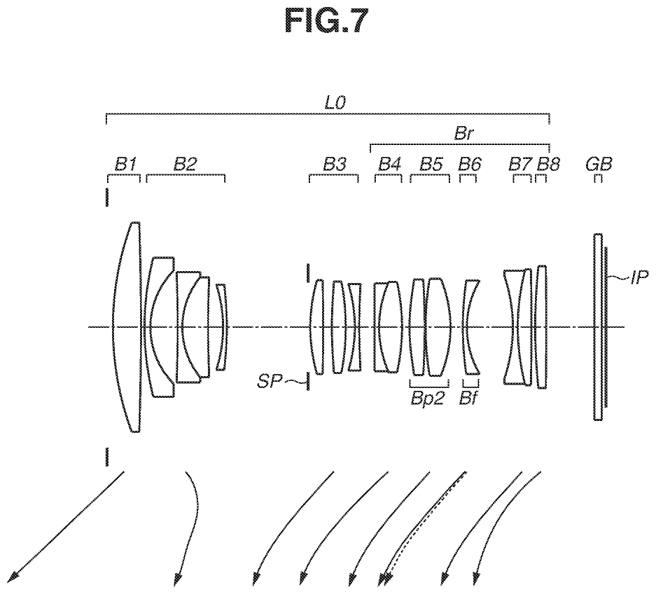

FIGS. 1, 3, 5, and 7 are cross-sectional views illustrating zoom lenses L0 according to first to fourth exemplary embodiments. The zoom lenses L0 according to the exemplary embodiments are zoom lenses for use in imaging apparatuses, such as digital video cameras, digital still cameras, broadcasting cameras, silver-halide film cameras, monitoring cameras, and on-vehicle cameras.

In each cross-sectional view illustrating lenses, the left side is an object side, and the right side is an image side. The zoom lenses L0 according to the exemplary embodiments can be used as a projection lens of a projector. In this case, the left side is a screen side, and the right side is a projection image side.

The zoom lenses L0 according to the exemplary embodiments each consist of a first lens unit B1 having a positive refractive power, a second lens unit B2 having a negative refractive power, a third lens unit B3 having a positive refractive power, and a subsequent group Br including three or more lens units, arranged in this order from the object side toward the image side. In zooming, an interval between adjacent lens units changes. Each lens unit can consist of a single lens or a plurality of lenses. A lens unit can include an aperture stop.

Solid line arrows at the bottom of each cross-sectional view illustrating lenses indicate trajectories along which the lens units move in zooming from a wide angle end toward a telephoto end in a case where an object at infinity is focused. A dashed line arrow at the bottom of each cross-sectional view illustrating lenses indicates a trajectory along which a focusing unit Bf moves in zooming from the wide angle end toward the telephoto end in a case where a near object is focused.

In each cross-sectional view illustrating lenses, there is an aperture stop SP. There is an image plane IP, and in a case where a zoom lens according to an exemplary embodiment is used in a digital still camera or a digital video camera, an imaging surface of a solid-state image sensor (photoelectric conversion element), such as a charge-coupled device (CCD) sensor or a complementary metal-oxide semiconductor (CMOS) sensor, is positioned on the image plane IP. In a case where a zoom lens according to an exemplary embodiment is used as an imaging optical system of a silver-halide film camera, a photosensitive surface corresponding to a film surface is positioned on the image plane IP.

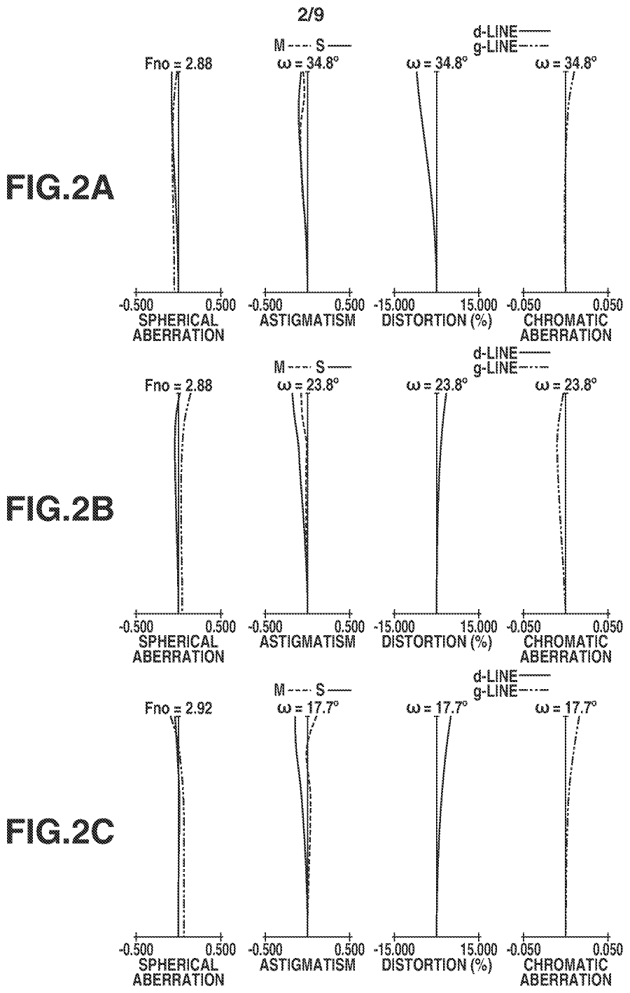

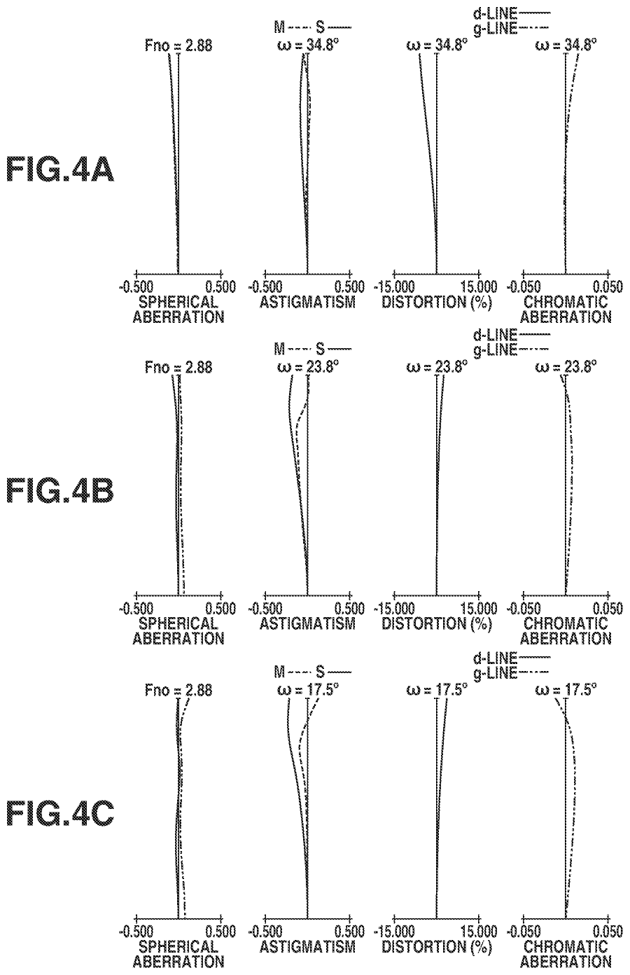

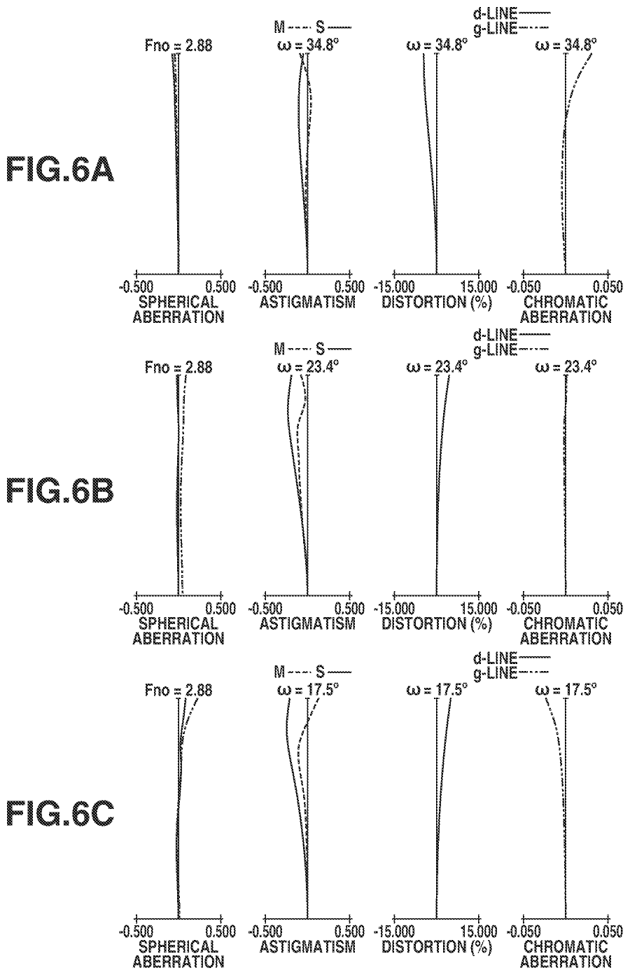

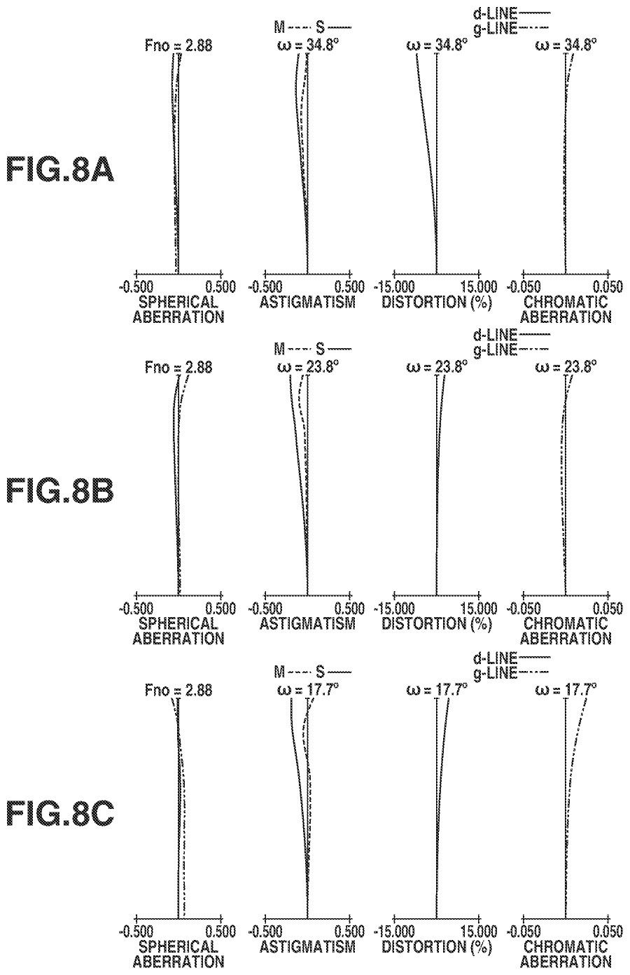

FIGS. 2A to 2C, 4A to 4C, 6A to 6C, and 8A to 8C are aberration diagrams illustrating the zoom lenses according to the first to fourth exemplary embodiments at the wide angle end, a zoom intermediate position, and the telephoto end in a case where an object at infinity is focused.

In each spherical aberration diagram, an f-number Fno is an f-number, and spherical aberration amounts with respect to the d-line (wavelength: 587.6 nm) and the g-line (wavelength: 435.8 nm) are illustrated. In each astigmatism diagram, an aberration amount S is an aberration amount in a sagittal image plane, and an aberration amount M is an aberration amount in a meridional image plane. In each distortion aberration diagram, a distortion aberration amount with respect to the d-line is illustrated. In each chromatic aberration diagram, a magnification chromatic aberration amount with respect to the g-line is illustrated. Imaging half angles of view @) (° are imaging half angles of view.

Features of structures of the zoom lenses according to the exemplary embodiments will be described below.

In the zoom lenses L0 according to the exemplary embodiments, the first lens unit B1 is configured to have a positive refractive power, and the second lens unit B2 is configured to have a negative refractive power, whereby a principal point is positioned on the object side and a total lens length (a distance along an optical axis from a lens surface closest to the object side in the zoom lens L0 to the image plane IP) is shortened. The third lens unit B3 is configured to have a positive refractive power to prevent axial chromatic aberrations that occur in the second lens unit B2, especially at the telephoto end. Furthermore, the subsequent group Br including three or more lens units is positioned to prevent changes in various aberrations that occur in zooming while a high zoom ratio is achieved.

In zooming from the wide angle end toward the telephoto end, the first lens unit B1 moves toward the object side to shorten the total lens length at the wide angle end. Furthermore, the third lens unit B3 and all the lens units of the subsequent group Br move toward the object side to prevent significant changes in air intervals between adjacent lens units. Consequently, heights of axial marginal rays incident on the lens units from the optical axis at the telephoto end and heights of off-axis rays from the optical axis are prevented from becoming high, and this makes it possible to reduce diameters of lenses arranged in the lens units.

In zooming from the wide angle end toward the telephoto end, the second lens unit B2 moves in a trajectory that is convex toward the image side to reduce a field curvature amount at a zoom intermediate position.

The zoom lenses L0 according to the exemplary embodiments are configured to satisfy the following inequalities:

$$3.5 < f 1 / \vert f 2 \vert < 5.33 , and \qquad ( 1 )$$

$$0.3 < fr / \vert f 2 \vert < 2.3 . \qquad ( 2 )$$

In the inequalities, f1 is a focal length of the first lens unit B1, f2 is a focal length of the second lens unit B2, and fr is a combined focal length of the subsequent group Br at the wide angle end.

Inequalities (1) and (2) are for realizing correction of various aberrations, a high zoom ratio, and size reduction.

In a case where the refractive power of the second lens unit B2 becomes excessively high beyond an upper limit of inequality (1), it becomes difficult to correct magnification chromatic aberrations, especially at the wide angle end, and changes in field curvature that occur in zooming. In a case where the refractive power of the second lens unit B2 becomes excessively low beyond a lower limit of inequality (1), an amount by which the second lens unit B2 is to move in zooming in order to achieve a high zoom ratio increases. Consequently, the total lens length becomes long. This is undesirable.

In a case where the refractive power of the subsequent group Br becomes excessively low beyond an upper limit of inequality (2), it becomes difficult to prevent spherical aberrations and axial chromatic aberrations that occur in the second lens unit B2, especially at the telephoto end. In a case where the refractive power of the subsequent group Br becomes excessively high beyond a lower limit of inequality (2), the principal point of the entire system is positioned on the image side. Consequently, the total lens length becomes long. This is undesirable.

With the above-described configuration, a zoom lens with high optical performance, a high zoom ratio, and a small size is realized.

In some embodiments, at least one of the upper and lower limits of the numerical range of one of inequalities (1) and (2) is a numerical value of the following inequality (1a) or (2a):

$$3.7 < f 1 / \vert f 2 \vert < 5.33 , or \qquad ( 1 a )$$

$$0.6 < fr / \vert f 2 \vert < 2.2 . \qquad ( 2 a )$$

And in some embodiments, at least one of the upper and lower limits of the numerical range of one of the 1 inequalities (1) and (2) is a range of the following inequality (1b) or (2b):

$$4. < f 1 / \vert f 2 \vert < 5.32 , or \qquad ( 1 b )$$

$$1. < fr / \vert f 2 \vert < 2.1 . \qquad ( 2 b )$$

Example configurations of the zoom lenses L0 according to the exemplary embodiments will be described below.

The first lens unit B1 may desirably consist of a single lens. With the first lens unit B1 consisting of the single lens, it becomes possible to reduce the thickness of the first lens unit B1 in the optical axis direction and to shorten the total lens length.

The second lens unit B2 may desirably consist of four lenses. With the second lens unit B2 consisting of the four lenses, it becomes possible to prevent changes in field curvature that occur, especially in zooming.

The third lens unit B3 may desirably consist of a positive lens, a positive lens, and a negative lens arranged in this order from the object side toward the image side. This makes it possible to position a principal point of the third lens unit B3 on the object side and to shorten the total lens length.

The subsequent group Br may desirably include the focusing unit Bf configured to move in focusing. Since off-axis rays that travel through the lenses in the subsequent group Br are relatively low in height from the optical axis, the focusing unit Bf can be reduced in a diameter direction of the focusing unit Bf.

Furthermore, at least one lens unit positioned closer to the image side than the focusing unit Bf may desirably include one or more negative lenses and one or more positive lenses. With the one or more negative lenses and the one or more positive lenses positioned closer to the image side than the focusing unit Bf is, changes in magnification chromatic aberrations that occur in focusing are prevented.

The focusing unit Bf may desirably consist of a single lens. With the focusing unit Bf consisting of the single lens, it becomes possible to reduce the thickness of the focusing unit Bf in the optical axis direction.

The subsequent group Br may desirably include a lens unit Bp2 positioned adjacent to the object side of the focusing unit Bf and having a positive refractive power, and the lens unit Bp2 may desirably have the highest refractive power among the lens units arranged in the subsequent group Br. This makes it possible to place the focusing unit Bf at a position with a low height from the optical axis for off-axis rays and to reduce the focusing unit Bf in the diameter direction of the focusing unit Bf.

Inequalities that the zoom lenses L0, according to the exemplary embodiments, may desirably satisfy will be described below.

The zoom lenses L0 according to the exemplary embodiments may desirably satisfy one or more of the following inequalities:

$$1.34 < f 3 / \vert f 2 \vert < 4.26 , \qquad ( 3 )$$

$$1.31 < f 1 / ft < 2.81 , \qquad ( 4 )$$

$$0.66 < \vert f 2 \vert / fw < 1.41 , \qquad ( 5 )$$

$$1.14 < Lt / ft < 2.49 , \qquad ( 6 )$$

$$1.52 < Lw / fr < 4.1 , \qquad ( 7 )$$

$$0.5 < fs / f 3 < 1.85 , \qquad ( 8 )$$

$$1. < \vert ff / f 2 \vert < 2.74 , \qquad ( 9 )$$

$$0.75 < \vert ff \vert / fr < 1.81 , \qquad ( 10 )$$

$$3.5 < f 1 / fp 2 < 7.19 , and \qquad ( 11 )$$

$$1.35 < f 3 / fp 2 < 5.26 . \qquad ( 12 )$$

In the inequalities, f3 is a focal length of the third lens unit B3, ft is a focal length of the entire system at the telephoto end, fw is a focal length of the entire system at the wide angle end, Lt is a distance along the optical axis from a lens surface closest to the object side to a lens surface closest to the image side at the telephoto end, and Lw is a distance along the optical axis from a lens surface closest to the object side to a lens surface closest to the image side at the wide angle end.

Further, fs is a focal length of a positive lens arranged in the third lens unit B3 and having an aspherical shape, ff is a focal length of the focusing unit Bf of the subsequent group Br, fp2 is a focal length of the lens unit Bp2 having the highest refractive power among the lens units arranged in the subsequent group Br and having a positive refractive power, and fs is a focal length of a positive lens having the highest refractive power in a case where the third lens unit B3 includes a plurality of positive lenses having an aspherical shape.

Technical meanings of inequalities (3) to (12) will be described below.

In a case where the refractive power of the third lens unit B3 becomes excessively low beyond an upper limit of inequality (3), an amount by which the third lens unit B3 is to move in zooming increases, and the total lens length becomes long. In a case where the refractive power of the third lens unit B3 becomes excessively high beyond a lower limit of inequality (3), it becomes difficult to correct spherical aberrations across an entire zoom range.

In a case where the refractive power of the first lens unit B1 becomes excessively low beyond an upper limit of inequality (4), an amount by which the first lens unit B1 is to move in zooming increases, and the total lens length becomes long. In a case where the refractive power of the first lens unit B1 becomes excessively high beyond a lower limit of inequality (4), it becomes difficult to correct spherical aberrations, especially at the telephoto end.

In a case where the refractive power of the second lens unit B2 becomes excessively low beyond an upper limit of inequality (5), an amount by which the second lens unit B2 is to move in zooming increases, and the total lens length becomes long. In a case where the refractive power of the second lens unit B2 becomes excessively high beyond a lower limit of inequality (5), it becomes difficult to correct changes in field curvature that occur in zooming.

Beyond an upper limit of inequality (6), the total lens length at the telephoto end becomes excessively long. In a case where the total lens length at the telephoto end becomes excessively short beyond a lower limit of inequality (6), especially the refractive power of the first lens unit B1 becomes excessively high, and it becomes difficult to correct spherical aberrations at the telephoto end.

Beyond an upper limit of inequality (7), the total lens length at the wide angle end becomes excessively long. In a case where the total lens length at the wide angle end becomes excessively short beyond a lower limit of inequality (7), especially the refractive power of the first lens unit B1 becomes excessively high, and it becomes difficult to correct spherical aberrations at the telephoto end.

In a case where the refractive power of a positive lens having an aspherical shape in the third lens unit B3 becomes excessively low beyond an upper limit of inequality (8), it becomes difficult to enhance the refractive power of the third lens unit B3 within an appropriate range, and the total lens length becomes long. In a case where the refractive power of a positive lens having an aspherical shape in the third lens unit B3 becomes excessively high beyond a lower limit of inequality (8), it becomes difficult to correct spherical aberrations, especially at the telephoto end.

In a case where the refractive power of the focusing unit Bf becomes excessively low beyond an upper limit of inequality (9), an amount by which the focusing unit Bf is to move in focusing increases, so that a space for the movement is increased. Consequently, the total lens length becomes long. In a case where the refractive power of the focusing unit Bf becomes excessively high beyond a lower limit of inequality (9), it becomes difficult to correct field curvatures, especially at the wide angle end.

In a case where the refractive power of the subsequent group Br becomes excessively high beyond an upper limit of inequality (10), the principal point of the entire system is positioned on the image side. Consequently, the total lens length becomes long. In a case where the refractive power of the focusing unit Bf becomes excessively high beyond a lower limit of inequality (10), it becomes difficult to correct field curvatures, especially at the wide angle end.

In a case where the refractive power of the lens unit Bp2 having the highest refractive power among the lens units arranged in the subsequent group Br and having a positive refractive power becomes excessively high beyond an upper limit of inequality (11), it becomes especially difficult to correct coma aberrations and field curvatures. In a case where the refractive power of the first lens unit B1 becomes excessively high beyond a lower limit of inequality (11), it becomes difficult to correct spherical aberrations, especially at the telephoto end.

In a case where the refractive power of the lens unit Bp2 having the highest refractive power among the lens units arranged in the subsequent group Br and having a positive refractive power becomes excessively high beyond an upper limit of inequality (12), it becomes especially difficult to correct coma aberrations and field curvatures. In a case where the refractive power of the third lens unit B3 becomes excessively high beyond a lower limit of inequality (12), it becomes difficult to correct spherical aberrations, especially at the wide angle end.

In some embodiments, at least one of the upper and lower limits of inequalities (3) to (12) is set to the following numerical ranges:

$$1.53 < f 3 / \vert f 2 \vert < 3.93 , \qquad ( 3 a )$$

$$1.49 < f 1 / ft < 2.59 , \qquad ( 4 a )$$

$$0.75 < \vert f 2 \vert / fw < 1.3 , \qquad ( 5 a )$$

$$1.3 < Lt / ft < 2.3 , \qquad ( 6 a )$$

$$1.74 < Lw / fr < 3.78 , \qquad ( 7 a )$$

$$0.57 < fs / f 3 < 1.71 , \qquad ( 8 a )$$

$$1.15 < \vert ff / f 2 \vert < 2.53 , \qquad ( 9 a )$$

$$0.86 < \vert ff \vert / fr < 1.67 , \qquad ( 10 a )$$

$$4.01 < f 1 / fp 2 < 6.64 , and \qquad ( 11 a )$$

$$1.55 < f 3 / fp 2 < 4.85 . \qquad ( 12 a )$$

And in some embodiments, at least one of the upper and lower limits of inequalities (3) to (12) is set to the following numerical ranges:

$$1.81 < f 3 / \vert f 2 \vert < 3.44 , \qquad ( 3 b )$$

$$1.77 < f 1 / ft < 2.27 , \qquad ( 4 b )$$

$$0.89 < \vert f 2 \vert / fw < 1.14 , \qquad ( 5 b )$$

$$1.55 < Lt / ft < 2.01 , \qquad ( 6 b )$$

$$2.07 < Lw / fr < 3.31 , \qquad ( 7 b )$$

$$0.68 < fs / f 3 < 1.49 , \qquad ( 8 b )$$

$$1.36 < \vert ff / f 2 \vert < 2.22 , \qquad ( 9 b )$$

$$1.02 < \vert ff \vert / fr < 1.47 , \qquad ( 10 b )$$

$$4.76 < f 1 / fp 2 < 5.81 , and \qquad ( 11 b )$$

$$1.84 < f 3 / fp 2 < 4.25 . \qquad ( 12 b )$$

Details of configurations of the zoom lenses L0 according to the exemplary embodiments will be described below.

The first exemplary embodiment will be described below. The zoom lens L0 according to the first exemplary embodiment consists of the first lens unit B1 having a positive refractive power, the second lens unit B2 having a negative refractive power, the third lens unit B3 having a positive refractive power, and the subsequent group Br, arranged in this order from the object side toward the image side. The subsequent group Br consists of a fourth lens unit B4 having a negative refractive power, a fifth lens unit B5 having a positive refractive power, a sixth lens unit B6 having a negative refractive power, and a seventh lens unit B7 having a negative refractive power, arranged in this order from the object side toward the image side. By suitably arranging the lens units having a positive refractive power and the lens units having a negative refractive power, various aberrations are corrected satisfactorily across the entire zoom range.

The second lens unit B2 consists of four lenses that are a negative lens, a negative lens, a positive lens, and a negative lens arranged in this order from the object side toward the image side. The second lens unit B2 consists of the four lenses, and the positive lens is positioned therein, whereby changes in magnification chromatic aberrations that occur in the second lens unit B2 in zooming are prevented.

In order to reduce the thickness in the optical axis direction and the size in the diameter direction of the units that move in focusing, the sixth lens unit B6 consisting of a single negative lens moves toward the image side in focusing from infinity to close distance. Furthermore, the single negative lens of the sixth lens unit B6 has a meniscus shape having a convex surface facing toward the object side. With the meniscus shape having the convex surface facing toward the object side, changes in spherical aberrations that occur in focusing are prevented.

An aperture stop that determines the f-number Fno is positioned closest to the object side in the third lens unit B3. With the aperture stop positioned closest to the object side in the third lens unit B3 having a relatively small diameter, it becomes possible to reduce the diameter of the aperture stop.

The second exemplary embodiment will be described below. The zoom lens L0 according to the second exemplary embodiment consists of the first lens unit B1 having a positive refractive power, the second lens unit B2 having a negative refractive power, the third lens unit B3 having a positive refractive power, and the subsequent group Br, arranged in this order from the object side toward the image side. The subsequent group Br consists of the fourth lens unit B4 having a positive refractive power, the fifth lens unit B5 having a negative refractive power, and the sixth lens unit B6 having a negative refractive power, arranged in this order from the object side toward the image side.

In the zoom lens L0 according to the second exemplary embodiment, the number of lens units in the subsequent group Br is reduced, unlike the first exemplary embodiment, whereby relative decentering of the lens units that occurs in zooming is prevented, making it easier to achieve high optical performance.

The third exemplary embodiment will be described below. The zoom lens L0 according to the third exemplary embodiment consists of the first lens unit B1 having a positive refractive power, the second lens unit B2 having a negative refractive power, the third lens unit B3 having a positive refractive power, and the subsequent group Br, arranged in this order from the object side toward the image side. The subsequent group Br consists of the fourth lens unit B4 having a positive refractive power, the fifth lens unit B5 having a negative refractive power, and the sixth lens unit B6 having a positive refractive power, arranged in this order from the object side toward the image side.

In the zoom lens L0 according to the third exemplary embodiment, the sixth lens unit B6 positioned adjacent to the object side of the fifth lens unit B5 having a negative refractive power is configured to have a positive refractive power, unlike the second exemplary embodiment, making it easier to prevent magnification chromatic aberrations that occur in the fifth lens unit B5.

The fourth exemplary embodiment will be described below. The zoom lens L0 according to the fourth exemplary embodiment consists of the first lens unit B1 having a positive refractive power, the second lens unit B2 having a negative refractive power, the third lens unit B3 having a positive refractive power, and the subsequent group Br, arranged in this order from the object side toward the image side. The subsequent group Br consists of the fourth lens unit B4 having a negative refractive power, the fifth lens unit B5 having a positive refractive power, the sixth lens unit B6 having a negative refractive power, the seventh lens unit B7 having a negative refractive power, and an eighth lens unit B8 having a positive refractive power, arranged in this order from the object side toward the image side.

In the zoom lens L0 according to the fourth exemplary embodiment, the eighth lens unit B8 having a positive refractive power is positioned adjacent to the image side of the seventh lens unit B7 having a negative refractive power, whereby changes in field curvature that occur in zooming are prevented.

First to fourth numerical examples respectively corresponding to the first to fourth exemplary embodiments will be presented below.

In surface data of the numerical examples, r is a radius of curvature of an optical surface, and d(mm) is an axial interval (distance along the optical axis) between the mth surface and the (m+1)th surface, where m is a surface number counted from a light incident side. Further, nd is a refractive index of an optical member at the d-line, and vd is an Abbe number of an optical member. The Abbe number vd of a material is

$$vd = ( Nd - 1 ) / ( NF - NC ) ,$$

where Nd, NF, and NC are refractive indices of the material at the d-line (wavelength: 587.6 nm), the F-line (wavelength: 486.1 nm), the C-line (wavelength: 656.3 nm), and the g-line (wavelength: 435.8 nm).

Two surfaces closest to the image side correspond to a glass block (GB). With an X-axis being along the optical axis direction, an H-axis being along a direction vertical to the optical axis, and a light travel direction being positive, an aspherical shape is expressed by the following formula:

$$X = \frac{{H}^{2} / R}{1 + \sqrt{1 - ( 1 + K ) {( H / R )}^{2}}} + A 4 {H}^{4} + A 6 {H}^{6} + A 8 {H}^{8} + A 10 {H}^{10} + A 12 {H}^{12} ,$$

where R is a paraxial curvature radius, K is a conic constant, and A4, A6, A8, A10, and A12 are aspherical coefficients. Further, the symbol “*” refers to a surface having an aspherical shape, “e-x” refers to 10^{-x}, and Ba is a back focus and specifies an air-conversion distance from a final lens surface to the image plane. The term “wide angle” refers to the wide angle end, the term “intermediate” refers to the zoom intermediate position, and the term “telephoto” refers to the telephoto end. A surface of surface number 1 is a virtual surface. Configurations are not limited to those including a virtual surface, and the surface of surface number 1 can be deleted.

### First Numerical Example

Unit mm
Surface Data

| Surface Number | r | d | nd | νd |
|---|---|---|---|---|
| 1 | ∞ | 1.60 | | |
| 2 | 71.698 | 7.40 | 1.49700 | 81.7 |
| 3 | −1074.771 | (variable) | | |
| 4 | 95.769 | 1.60 | 1.89190 | 37.1 |
| 5 | 22.455 | 7.05 | | |
| 6 | −369.959 | 1.25 | 1.60311 | 60.6 |
| 7 | 22.126 | 7.00 | 1.90366 | 31.3 |
| 8 | 412.508 | 4.86 | | |
| 9 | −36.457 | 1.00 | 1.85150 | 40.8 |
| 10 | −89.252 | (variable) | | |
| 11 (stop) | ∞ | 0.65 | | |
| 12 | 43.928 | 3.45 | 2.00100 | 29.1 |
| 13 | −750.000 | 2.40 | | |
| 14* | 106.432 | 3.70 | 1.58313 | 59.4 |
| 15* | −70.798 | 2.33 | | |
| 16 | −41.445 | 1.20 | 1.77047 | 29.7 |
| 17 | 220.269 | (variable) | | |
| 18 | ∞ | 1.20 | 1.85478 | 24.8 |
| 19 | 28.842 | 6.10 | 1.49700 | 81.7 |
| 20 | −56.203 | (variable) | | |
| 21* | 55.622 | 3.80 | 1.58313 | 59.4 |
| 22* | −248.880 | 0.20 | | |
| 23 | 69.909 | 7.75 | 1.59522 | 67.7 |
| 24 | −31.690 | (variable) | | |
| 25 | 71.379 | 1.10 | 1.61340 | 44.3 |
| 26 | 23.380 | (variable) | | |
| 27 | −53.964 | 1.30 | 1.74400 | 44.8 |
| 28 | 43.097 | 4.80 | 1.92286 | 20.9 |
| 29 | −750.000 | (variable) | | |
| 30 | ∞ | 2.00 | 1.54400 | 66.3 |
| 31 | ∞ | (variable) | | |
| Image Plane | ∞ | | | |

Aspherical Surface Data
14^{th} Surface
K = 0.00000e+00 A4 = −5.91734e−06 A6 = −1.25922e−08
A8 = −6.96192e−11 A10 = −1.24634e−13 A12 = 3.32938e−16
15^{th} Surface
K = 0.00000e+00 A4 = −2.81431e−06 A6 = −1.15888e−08
A8 = −1.20810e−10 A10 = 3.67743e−13 A12 = −6.62375e−16
21^{st} Surface
K = 0.00000e+00 A4 = −2.16306e−06 A6 = −3.51669e−08
A8 = 3.80997e−12 A10 = −8.02806e−13 A12 = 7.68937e−16
22^{nd} Surface
K = 0.00000e+00 A4 = 1.35282e−05 A6 = −2.86368e−08
A8 = 3.89958e−11 A10 = −1.08816e−12 A12 = 1.83610e−15

Various Data

| | |
|---|---|
| Zoom Ratio | 2.36 |

| | Wide Angle | Intermediate | Telephoto |
|---|---|---|---|
| Focal Length | 28.80 | 49.00 | 67.90 |
| F-Number | 2.88 | 2.88 | 2.92 |
| Half Angle of View | 34.93 | 23.82 | 17.67 |
| Image Height | 21.64 | 21.64 | 21.64 |
| Total Lens Length | 132.38 | 144.25 | 158.83 |
| Ba | 15.39 | 26.31 | 34.87 |
| d3 | 0.85 | 15.70 | 26.56 |
| d10 | 21.64 | 7.73 | 2.90 |
| d17 | 4.86 | 2.83 | 2.01 |
| d20 | 2.00 | 4.04 | 4.86 |
| d24 | 3.22 | 3.12 | 2.00 |
| d26 | 12.68 | 12.78 | 13.90 |
| d29 | 13.00 | 23.93 | 32.48 |
| d31 | 1.09 | 1.09 | 1.09 |

Zoom Lens Unit Data

| Unit | Starting Surface | Focal Length |
|---|---|---|
| B1 | 2 | 135.53 |
| B2 | 4 | −27.10 |
| B3 | 11 | 51.68 |
| B4 | 18 | −321.04 |
| B5 | 21 | 26.75 |
| B6 | 25 | −57.18 |
| B7 | 27 | −120.17 |
| GB | 30 | ∞ |

### Second Numerical Example

Unit mm
Surface Data

| Surface Number | r | d | nd | νd |
|---|---|---|---|---|
| 1 | ∞ | 1.60 | | |
| 2 | 64.109 | 7.17 | 1.49700 | 81.5 |
| 3 | 4538.818 | (variable) | | |
| 4 | 110.231 | 1.80 | 1.59522 | 67.7 |
| 5 | 21.806 | 8.58 | | |
| 6 | −146.659 | 1.50 | 1.61340 | 44.3 |
| 7 | 25.001 | 4.89 | 2.00100 | 29.1 |
| 8 | 94.515 | 4.46 | | |
| 9 | −42.715 | 1.30 | 1.53775 | 74.7 |
| 10 | −130.569 | (variable) | | |
| 11 (stop) | ∞ | 1.80 | | |
| 12 | 33.675 | 2.98 | 1.59522 | 67.7 |
| 13 | 92.568 | 2.87 | | |
| 14* | 75.661 | 3.74 | 1.58313 | 59.4 |
| 15* | −96.472 | 3.66 | | |
| 16 | −28.115 | 1.22 | 1.77047 | 29.7 |
| 17 | −80.146 | (variable) | | |
| 18* | 57.289 | 5.74 | 1.58313 | 59.4 |
| 19* | −37.418 | 0.26 | | |
| 20 | 956.173 | 1.40 | 1.85478 | 24.8 |
| 21 | 71.298 | 7.39 | 1.59522 | 67.7 |
| 22 | −29.436 | (variable) | | |
| 23 | 102.308 | 1.00 | 1.78470 | 26.3 |
| 24 | 27.735 | (variable) | | |
| 25 | −323.671 | 1.60 | 1.75500 | 52.3 |
| 26 | 27.770 | 5.39 | 1.92286 | 20.9 |
| 27 | 135.653 | (variable) | | |
| 28 | ∞ | 2.00 | 1.54400 | 66.3 |
| 29 | ∞ | (variable) | | |
| Image Plane | ∞ | | | |

Aspherical Surface Data
14^{th} Surface
K = 0.00000e+00 A4 = −4.99308e−06 A6 = 9.56563e−11
A8 = 2.28657e−11 A10 = 6.19341e−13
15^{th} Surface
K = 0.00000e+00 A4 = −3.09477e−06 A6 = 9.21828e−09
A8 = −7.68728e−11 A10 = 9.48917e−13
18^{th} Surface
K = 0.00000e+00 A4 = −5.65839e−06 A6 = 5.09383e−08
A8 = 9.98074e−11 A10 = −5.71949e−13 A12 = 2.69551e−15
19^{th} Surface
K = 0.00000e+00 A4 = 2.10447e−05 A6 = 4.37658e−08
A8 = 9.78884e−11 A10 = −3.21204e−13 A12 = 2.51468e−15

Various Data

| | |
|---|---|
| Zoom Ratio | 2.39 |

| | Wide Angle | Intermediate | Telephoto |
|---|---|---|---|
| Focal Length | 28.80 | 49.00 | 68.80 |
| F-Number | 2.88 | 2.88 | 2.88 |
| Half Angle of View | 34.92 | 23.68 | 17.46 |
| Image Height | 21.64 | 21.64 | 21.64 |
| Total Lens Length | 127.13 | 138.45 | 151.03 |
| Ba | 15.39 | 27.19 | 37.02 |
| d3 | 0.85 | 14.36 | 23.61 |
| d10 | 17.85 | 6.94 | 2.00 |
| d17 | 7.91 | 4.82 | 3.27 |
| d22 | 7.33 | 4.02 | 2.00 |
| d24 | 7.45 | 10.76 | 12.79 |
| d27 | 13.00 | 24.80 | 34.63 |
| d29 | 1.09 | 1.09 | 1.09 |

Zoom Lens Unit Data

| Unit | Starting Surface | Focal Length |
|---|---|---|
| B1 | 2 | 130.77 |
| B2 | 4 | −31.26 |
| B3 | 11 | 102.51 |
| B4 | 18 | 25.35 |
| B5 | 23 | −48.78 |
| B6 | 25 | −330.93 |
| GB | 28 | ∞ |

### Third Numerical Example

Unit mm
Surface Data

| Surface Number | r | d | nd | νd |
|---|---|---|---|---|
| 1 | ∞ | 1.60 | | |
| 2 | 69.090 | 7.40 | 1.49700 | 81.5 |
| 3 | −803.300 | (variable) | | |
| 4 | 121.485 | 1.80 | 1.59522 | 67.7 |
| 5 | 22.418 | 8.77 | | |
| 6 | −134.878 | 1.50 | 1.61340 | 44.3 |
| 7 | 26.095 | 4.63 | 2.00100 | 29.1 |
| 8 | 103.970 | 4.45 | | |
| 9 | −39.791 | 1.30 | 1.53775 | 74.7 |
| 10 | −136.339 | (variable) | | |
| 11 (stop) | ∞ | 1.80 | | |
| 12 | 31.872 | 3.21 | 1.59522 | 67.7 |
| 13 | 95.837 | 2.80 | | |
| 14* | 74.280 | 3.64 | 1.58313 | 59.4 |
| 15* | −111.093 | 3.73 | | |
| 16 | −28.556 | 1.33 | 1.77047 | 29.7 |
| 17 | −84.332 | (variable) | | |
| 18* | 58.568 | 5.63 | 1.58313 | 59.4 |
| 19* | −37.260 | 0.78 | | |
| 20 | 1434.050 | 1.40 | 1.85478 | 24.8 |
| 21 | 75.530 | 7.14 | 1.59522 | 67.7 |
| 22 | −29.651 | (variable) | | |
| 23 | 139.647 | 1.00 | 1.78470 | 26.3 |
| 24 | 27.157 | (variable) | | |
| 25 | −3733.823 | 1.60 | 1.75500 | 52.3 |
| 26 | 29.164 | 5.85 | 1.92286 | 20.9 |
| 27 | 204.217 | (variable) | | |
| 28 | ∞ | 2.00 | 1.54400 | 66.3 |
| 29 | ∞ | (variable) | | |
| Image Plane | ∞ | | | |

Aspherical Surface Data
14^{th} Surface
K = 0.00000e+00 A4 = −5.32077e−06 A6 = 7.65017e−09
A8 = −4.96809e−11 A10 = 1.19886e−12
15^{th} Surface
K = 0.00000e+00 A4 = −4.15343e−06 A6 = 2.86367e−08
A8 = −2.46191e−10 A10 = 1.83092e−12
18^{th} Surface
K = 0.00000e+00 A4 = −7.75733e−06 A6 = 7.82802e−08
A8 = −5.68650e−11 A10 = −5.97309e−15 A12 = 2.47205e−15
19^{th} Surface
K = 0.00000e+00 A4 = 1.98553e−05 A6 = 5.79944e−08
A8 = 4.92930e−11 A10 = −1.42165e−13 A12 = 2.87702e−15

Various Data

| | |
|---|---|
| Zoom Ratio | 2.39 |

| | Wide Angle | Intermediate | Telephoto |
|---|---|---|---|
| Focal Length | 28.80 | 50.00 | 68.80 |
| F-Number | 2.88 | 2.88 | 2.88 |
| Half Angle of View | 34.92 | 23.26 | 17.46 |
| Image Height | 21.64 | 21.64 | 21.64 |
| Total Lens Length | 127.13 | 139.11 | 151.03 |
| Ba | 15.39 | 27.80 | 37.28 |
| d3 | 0.85 | 14.97 | 23.52 |
| d10 | 18.11 | 6.72 | 2.00 |
| d17 | 6.55 | 3.38 | 2.00 |
| d22 | 7.69 | 4.67 | 2.88 |
| d24 | 7.19 | 10.21 | 12.00 |
| d27 | 13.00 | 25.41 | 34.89 |
| d29 | 1.09 | 1.09 | 1.09 |

Zoom Lens Unit Data

| Unit | Starting Surface | Focal Length |
|---|---|---|
| B1 | 2 | 128.37 |
| B2 | 4 | −30.04 |
| B3 | 11 | 95.30 |
| B4 | 18 | 25.64 |
| B5 | 23 | −43.13 |
| B6 | 25 | 900.00 |
| GB | 28 | ∞ |

### Fourth Numerical Example

Unit mm
Surface Data

| Surface Number | r | d | nd | νd |
|---|---|---|---|---|
| 1 | ∞ | 1.60 | | |
| 2 | 79.594 | 7.59 | 1.49700 | 81.7 |
| 3 | −835.318 | (variable) | | |
| 4 | 73.280 | 1.60 | 1.89190 | 37.1 |
| 5 | 21.548 | 7.37 | | |
| 6 | −369.959 | 1.25 | 1.60311 | 60.6 |
| 7 | 21.168 | 6.95 | 1.90366 | 31.3 |
| 8 | 289.158 | 4.06 | | |
| 9 | −36.165 | 1.00 | 1.85150 | 40.8 |
| 10 | −91.177 | (variable) | | |
| 11 (stop) | ∞ | 0.60 | | |
| 12 | 44.013 | 3.47 | 2.00100 | 29.1 |
| 13 | −750.000 | 2.36 | | |
| 14* | 107.718 | 3.73 | 1.58313 | 59.4 |
| 15* | −69.983 | 2.47 | | |
| 16 | −39.067 | 1.20 | 1.77047 | 29.7 |
| 17 | 199.294 | (variable) | | |
| 18 | ∞ | 1.20 | 1.85478 | 24.8 |
| 19 | 29.445 | 6.20 | 1.49700 | 81.7 |
| 20 | −54.091 | (variable) | | |
| 21* | 54.923 | 4.13 | 1.58313 | 59.4 |
| 22* | −150.167 | 0.20 | | |
| 23 | 75.662 | 6.75 | 1.59522 | 67.7 |
| 24 | −33.194 | (variable) | | |
| 25 | 83.342 | 1.10 | 1.61340 | 44.3 |
| 26 | 24.485 | (variable) | | |
| 27 | −41.988 | 1.30 | 1.74400 | 44.8 |
| 28 | 59.444 | 3.71 | 1.92286 | 20.9 |
| 29 | −750.000 | (variable) | | |
| 30 | 150.000 | 3.00 | 2.00100 | 29.1 |
| 31 | −1033.371 | (variable) | | |
| 32 | ∞ | 2.00 | 1.54400 | 66.3 |
| 33 | ∞ | (variable) | | |
| Image Plane | ∞ | | | |

Aspherical Surface Data
14^{th} Surface
K = 0.00000e+00 A4 = −4.20525e−06 A6 = −3.82772e−08
A8 = 2.77210e−10 A10 = −1.84598e−12 A12 = 4.13300e−15
15^{th} Surface
K = 0.00000e+00 A4 = −7.76915e−07 A6 = −4.58293e−08
A8 = 3.25378e−10 A10 = −1.82949e−12 A12 = 3.89584e−15
21^{st} Surface
K = 0.00000e+00 A4 = −4.04521e−06 A6 = −3.55365e−08
A8 = 3.62232e−11 A10 = −4.52586e−13 A12 = −5.35347e−16
22^{nd} Surface
K = 0.00000e+00 A4 = 9.66538e−06 A6 = −2.63857e−08
A8 = 2.80285e−11 A10 = −5.56106e−13 A12 = 1.71401e−16

Various Data

| | |
|---|---|
| Zoom Ratio | 2.36 |

| | Wide Angle | Intermediate | Telephoto |
|---|---|---|---|
| Focal Length | 28.80 | 49.00 | 67.90 |
| F-Number | 2.88 | 2.88 | 2.88 |
| Half Angle of View | 34.93 | 23.82 | 17.67 |
| Image Height | 21.64 | 21.64 | 21.64 |
| Total Lens Length | 133.93 | 147.58 | 164.79 |
| Ba | 15.39 | 26.87 | 33.17 |
| d3 | 0.93 | 17.37 | 29.29 |
| d10 | 21.92 | 7.63 | 3.07 |
| d17 | 4.14 | 2.68 | 2.05 |
| d20 | 2.00 | 3.46 | 4.09 |
| d24 | 3.31 | 3.13 | 2.00 |
| d26 | 12.42 | 12.60 | 13.73 |
| d29 | 1.00 | 1.00 | 4.55 |
| d31 | 13.00 | 24.49 | 30.79 |
| d33 | 1.09 | 1.09 | 1.09 |

Zoom Lens Unit Data

| Unit | Starting Surface | Focal Length |
|---|---|---|
| B1 | 2 | 146.62 |
| B2 | 4 | −27.63 |
| B3 | 11 | 54.59 |
| B4 | 18 | −400.00 |
| B5 | 21 | 26.50 |
| B6 | 25 | −56.93 |
| B7 | 27 | −74.69 |
| B8 | 30 | 131.02 |
| GB | 32 | ∞ |

Various values in the exemplary embodiments are presented in the following table.

TABLE 1

| | | First | Second | Third | Fourth |
|---|---|---|---|---|---|
| | | Exemplary | Exemplary | Exemplary | Exemplary |
| | | Embodi- | Embodi- | Embodi- | Embodi- |
| | | ment | ment | ment | ment |
| | fw | 28.800 | 28.800 | 28.800 | 28.800 |
| | ft | 67.900 | 68.800 | 68.800 | 67.900 |
| | f1 | 135.529 | 130.771 | 128.367 | 146.620 |
| | f2 | −27.100 | −31.262 | −30.043 | −27.632 |
| | f3 | 51.684 | 102.511 | 95.301 | 54.592 |
| | fr | 53.043 | 34.955 | 35.544 | 48.642 |
| | fp2 | 26.747 | 25.346 | 25.641 | 26.503 |
| | ff | −57.181 | −48.777 | −43.132 | −56.927 |
| | fs | 73.476 | 73.305 | 76.896 | 73.315 |
| | Lw | 115.395 | 110.147 | 110.147 | 116.947 |
| | Lt | 122.367 | 112.416 | 112.156 | 130.018 |
| Inequality (1) | f1/\|f2\| | 5.00 | 4.18 | 4.27 | 5.31 |
| Inequality (2) | fr/\|f2\| | 1.96 | 1.12 | 1.18 | 1.76 |
| Inequality (3) | f3/\|f2\| | 1.91 | 3.28 | 3.17 | 1.98 |
| Inequality (4) | f1/ft | 2.00 | 1.90 | 1.87 | 2.16 |
| Inequality (5) | \|f2\|/fw | 0.94 | 1.09 | 1.04 | 0.96 |
| Inequality (6) | Lt/ft | 1.80 | 1.63 | 1.63 | 1.91 |
| Inequality (7) | Lw/fr | 2.18 | 3.15 | 3.10 | 2.40 |
| Inequality (8) | fs/f3 | 1.42 | 0.72 | 0.81 | 1.34 |
| Inequality (9) | \|ff/f2\| | 2.11 | 1.56 | 1.44 | 2.06 |
| Inequality (10) | \|ff\|/fr | 1.08 | 1.40 | 1.21 | 1.17 |
| Inequality (11) | f1/fp2 | 5.07 | 5.16 | 5.01 | 5.53 |
| Inequality (12) | f3/fp2 | 1.93 | 4.04 | 3.72 | 2.06 |

### Imaging Apparatus

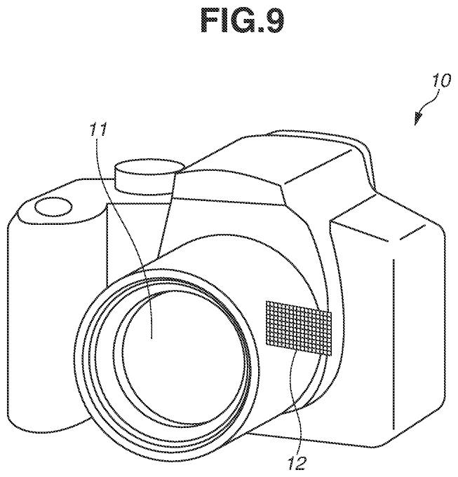

A digital still camera (imaging apparatus) that uses a zoom lens according to an exemplary embodiment of the present disclosure as an imaging optical system will be described below with reference to FIG. 9. In FIG. 9, an imaging optical system 11 includes a zoom lens according to one of the first to fourth exemplary embodiments. An image sensor (photoelectric conversion element) 12 is an image sensor, such as a CCD sensor or a CMOS sensor, built in a camera body 10. The image sensor 12 receives an optical image formed by the imaging optical system 11 and photoelectrically converts the received optical image. The camera body 10 can be a so-called single-lens reflex camera including a quick turn mirror or a so-called mirrorless camera without a quick turn mirror.

Application of the zoom lens L0 according to an exemplary embodiment of the present disclosure to an imaging apparatus, such as a digital still camera, makes it possible to capture images with a high resolution and a wide angle of view.

While desirable exemplary embodiments and examples of the present disclosure have been disclosed above, some embodiments of the present disclosure are not limited to the exemplary embodiments and the examples, and various combinations, modifications, and changes are possible within the spirit of the disclosure.

While the present disclosure has described exemplary embodiments, it is to be understood that some embodiments of the disclosure are not limited to the disclosed exemplary embodiments. The scope of the following claims is to be accorded the broadest interpretation so as to encompass all such modifications and equivalent structures and functions.

This application claims priority to Japanese Patent Application No. 2023-009357, which was filed on Jan. 25, 2023 and which is hereby incorporated by reference herein in its entirety.

What is claimed is:

1. A zoom lens comprising a first lens unit having a positive refractive power, a second lens unit having a negative refractive power, a third lens unit having a positive refractive power, and a subsequent group including three or more lens units, arranged in this order from an object side toward an image side, with an interval between adjacent lens units that changes in zooming,
wherein in zooming from a wide angle end toward a telephoto end, the first lens unit, the third lens unit, and all the lens units of the subsequent group move toward the object side, and the second lens unit moves in a trajectory that is convex toward the image side, and
wherein the following inequalities are satisfied:
$$3.5 < f 1 / \vert f 2 \vert < 5.33 , and \\ 0.3 < fr / \vert f 2 \vert < 2.3 ,$$
where f1 is a focal length of the first lens unit, f2 is a focal length of the second lens unit, and fr is a combined focal length of the subsequent group at the wide angle end.

2. The zoom lens according to claim 1, wherein the following inequality is satisfied:
$$1.34 < f 3 / \vert f 2 \vert < 4.26 ,$$
where f3 is a focal length of the third lens unit.

3. The zoom lens according to claim 1, wherein the following inequality is satisfied:
$$1.31 < f 1 / ft < 2.81 ,$$
where ft is a focal length of an entire system at the telephoto end.

4. The zoom lens according to claim 1, wherein the following inequality is satisfied:
$$0.66 < \vert f 2 \vert / fw < 1.41 ,$$
where fw is a focal length of an entire system at the wide angle end.

5. The zoom lens according to claim 1, wherein the following inequality is satisfied:
$$1.14 < Lt / ft < 2.49 ,$$
where Lt is a distance along an optical axis from a lens surface closest to the object side to a lens surface closest to the image side at the telephoto end, and ft is a focal length of an entire system at the telephoto end.

6. The zoom lens according to claim 1, wherein the following inequality is satisfied:
$$1.52 < Lw / fr < 4.1 ,$$
where Lw is a distance along an optical axis from a lens surface closest to the object side to a lens surface closest to the image side at the wide angle end.

7. The zoom lens according to claim 1,
wherein the third lens unit includes a positive lens having an aspherical shape, and
wherein the following inequality is satisfied:
$$0.5 < fs / f 3 < 1.85 ,$$
where fs is a focal length of the positive lens, and f3 is a focal length of the third lens unit.

8. The zoom lens according to claim 1, wherein the subsequent group includes a focusing unit configured to move in focusing.

9. The zoom lens according to claim 8, wherein the focusing unit consists of a single lens.

10. The zoom lens according to claim 8, wherein the subsequent group includes at least one lens unit positioned closer to the image side than the focusing unit is, and the at least one lens unit includes one or more negative lenses and one or more positive lenses.

11. The zoom lens according to claim 8, wherein the following inequality is satisfied:
$$1. < \vert ff / f 2 \vert < 2.74 ,$$
where ff is a focal length of the focusing unit.

12. The zoom lens according to claim 1, wherein the following inequality is satisfied:
$$0.75 < \vert ff \vert / fr < 1.81 ,$$
where ff is a focal length of the focusing unit.

13. The zoom lens according to claim 8, wherein a lens unit with the highest positive refractive power among the lens units arranged in the subsequent group is positioned adjacent to the object side of the focusing unit.

14. The zoom lens according to claim 1, wherein the following inequality is satisfied:
$$3.5 < f 1 / fp 2 < 7.19 ,$$
where fp2 is a focal length of a lens unit with the highest positive refractive power among the lens units arranged in the subsequent group.

15. The zoom lens according to claim 1, wherein the following inequality is satisfied:
$$1.35 < f 3 / fp 2 < 5.26 ,$$
where fp2 is a focal length of a lens unit with the highest positive refractive power among the lens units arranged in the subsequent group, and f3 is a focal length of the third lens unit.

16. The zoom lens according to claim 1, wherein the first lens unit consists of a single lens.

17. The zoom lens according to claim 1, wherein the second lens unit consists of four lenses.

18. The zoom lens according to claim 1, wherein the third lens unit consists of a positive lens, a positive lens, and a negative lens, arranged in this order from the object side toward the image side.

19. The zoom lens according to claim 1, wherein the subsequent group consists of a fourth lens unit having a negative refractive power, a fifth lens unit having a positive refractive power, a sixth lens unit having a negative refractive power, and a seventh lens unit having a negative refractive power, arranged in this order from the object side toward the image side.

20. The zoom lens according to claim 1, wherein the subsequent group consists of a fourth lens unit having a positive refractive power, a fifth lens unit having a negative refractive power, and a sixth lens unit having a negative refractive power, arranged in this order from the object side toward the image side.

21. The zoom lens according to claim 1, wherein the subsequent group consists of a fourth lens unit having a positive refractive power, a fifth lens unit having a negative refractive power, and a sixth lens unit having a positive refractive power, arranged in this order from the object side toward the image side.

22. The zoom lens according to claim 1, wherein the subsequent group consists of a fourth lens unit having a negative refractive power, a fifth lens unit having a positive refractive power, a sixth lens unit having a negative refractive power, a seventh lens unit having a negative refractive power, and a seventh lens unit having a positive refractive power, arranged in this order from the object side toward the image side.

23. An imaging apparatus comprising:
a zoom lens; and
an image sensor configured to receive an image formed by the zoom lens,
wherein the zoom lens includes a first lens unit having a positive refractive power, a second lens unit having a negative refractive power, a third lens unit having a positive refractive power, and a subsequent group including three or more lens units, arranged in this order from an object side toward an image side, with an interval between adjacent lens units that changes in zooming,
wherein in zooming from a wide angle end toward a telephoto end, the first lens unit, the third lens unit, and all the lens units of the subsequent group move toward the object side, and the second lens unit moves in a trajectory that is convex toward the image side, and
wherein the following inequalities are satisfied:
$$3.5 < f 1 / \vert f 2 \vert < 5.33 , and \\ 0.3 < fr / \vert f 2 \vert < 2.3 ,$$
where f1 is a focal length of the first lens unit, f2 is a focal length of the second lens unit, and fr is a combined focal length of the subsequent group at the wide angle end.
